(19) United States
(12) Patent Application Publication
(10) Pub. No.: US 2014/0143540 A1
(43) Pub. Date: May 22, 2014

(54) Method and Apparatus for Splitting and Encrypting Files in Computer Device

(71) Applicant: CLOUDIOH INC., Taipei City (TW)

(72) Inventor: Yan-Cheng Chang, New Taipei City (TW)

(73) Assignee: CLOUDIOH INC., Taipei City (TW)

(21) Appl. No.: 13/855,720

(22) Filed: Apr. 3, 2013

Related U.S. Application Data
(60) Provisional application No. 61/728,237, filed on Nov. 20, 2012.

(51) Int. Cl. G06F 21/62

(52) U.S. Cl. CPC G06F 21/6227
USPC 713/165

(57) ABSTRACT

A method for splitting a file in a computer device, the method comprising defining a moving window with a specified length and a random value; obtaining a content of the file by aligning the moving window to a specific place of the file; computing a result according to a cryptographic function of the content of the file; determining a cutting point according to the result and the random value; and splitting the file into segments according to the cutting point.

### CROSS REFERENCE TO RELATED APPLICATIONS

This application claims the benefit of U.S. Provisional Application No. 61/728,237, filed on Nov. 20, 2012, entitled “Secure and Efficient Systems for Operations against Encrypted Files”, the contents of which are incorporated herein in their entirety.

### BACKGROUND OF THE INVENTION

1. Field of the Invention

The present invention relates to a method and apparatus utilized in a computer device, and more particularly, to a method and apparatus for splitting and encrypting a file in a computer device.

2. Description of the Prior Art

Nowadays, users often collaborate on computer files in a shared storage provided by an internal corporate information technology department or an external service provider, such as Box, Dropbox or Google Drive. For example, if a file is stored in Google Drive, a collaborator who works on a local copy of the file in a personal computer using certain computer software can update the remote version in Google Drive with his local version. And other collaborators can further access the new version of the file. Such an updating process, in practice, is usually achieved by computer software implementing the so-called delta syncing algorithm which only transmits the difference (i.e. the delta) between two versions.

For privacy and confidentiality reasons, encrypting the file is desirable before uploading the file to the shared storage. However, common delta syncing algorithms cannot work on an encrypted file because two versions of a file shall have completely different patterns once encrypted. Therefore, a solution is to split the file into segments with a certain fixed length and encrypt each segment separately, so that if contents within a segment are changed, only the segment needs to be re-encrypted. However, this solution, unlike common delta syncing algorithms, cannot well deal with even trivial file modifications in that, for example, an insertion or deletion of the first character to/from the file will shift all the remaining characters and make all the segments different.

On the other hand, common hash functions are well-known for splitting files into variable-length segments so that the cutting points, which are derived from file contents, are not subject to insertions or deletions. Please refer to FIG. 4, which is a flowchart of a process 40 according to the prior art. The process 40 employs a hash function, which maps n bytes to k bits, to obtain cutting points to split a file. The process 40 includes the following steps:

Step 400: Start.

Step 402: Define a moving window of n bytes and a random value of k bits.

Step 404: Align the moving window to the beginning of the file.

Step 406: Compute a hash value according to the hash function of a content of the file covered by the moving window.

Step 408: Determine if the hash value equals the random value? If yes, execute Step 410; if no, execute Step 412.

Step 410: Set a starting position of the content of the file as the cutting point.

Step 412: Determine if the moving window covers the end of the file? If yes, execute Step 416; if no, execute Step 414.

Step 414: Slide the moving window by shifting one byte from the beginning to the end of the file and go back to Step 406.

Step 416: End.

In the process 40, the hash function is used for deriving the cutting points so that the file can be split into variable-length segments according to the cutting points. Since the cutting points are derived from file contents using common hash function, some information about the file contents may be leaked out, which leads that the file contents are not secure.

Therefore, to realize delta syncing against encrypted files, how to split and encrypt a file while keeping the file secure and confidential becomes an important issue.

### SUMMARY OF THE INVENTION

The present invention therefore provides a method and apparatus for splitting a file in a computer device, to efficiently encrypt the file and further keep the file secure and confidential.

A method for splitting a file in a computer device is disclosed. The method comprises defining a moving window with a specified length and a random value; obtaining a content of the file by aligning the moving window to a specific place of the file; computing a result according to a cryptographic function of the content of the file; determining a cutting point according to the result and the random value; and splitting the file into segments according to the cutting point.

A computer readable medium comprising multiple instructions stored in a computer readable device is disclosed. Upon executing these instructions, a computer performs the following steps: defining a moving window with a specified length and a random value; obtaining a content of a file by aligning the moving window to a specific place of the file; computing a result according to a cryptographic function of the content of the file; determining a cutting point according to the result and the random value; and splitting the file into segments according to the cutting point.

A computer device is disclosed. The computer device comprises a processing means; a storage unit; and a program code, stored in the storage unit, wherein the program code instructs the processing means to execute the following steps: defining a moving window with a specified length and a random value; obtaining a content of a file by aligning the moving window to a specific place of the file; computing a result according to a cryptographic function of the content of the file; determining a cutting point according to the result and the random value; and splitting the file into segments according to the cutting point.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an example of the present invention.

FIG. 2 is a schematic diagram of a computer apparatus according to an example of the present invention.

FIG. 3 is a flowchart of a process according to examples of the present invention.

FIG. 4 is a flowchart of a process according to the prior art.

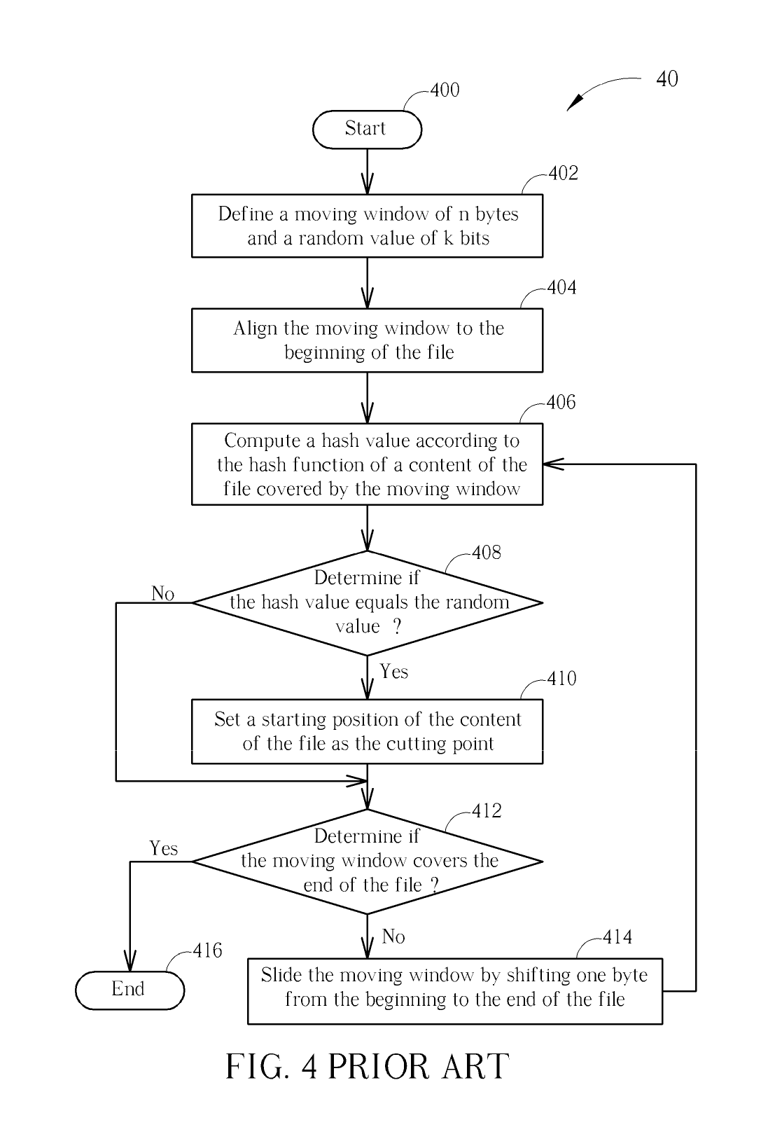

### DETAILED DESCRIPTION

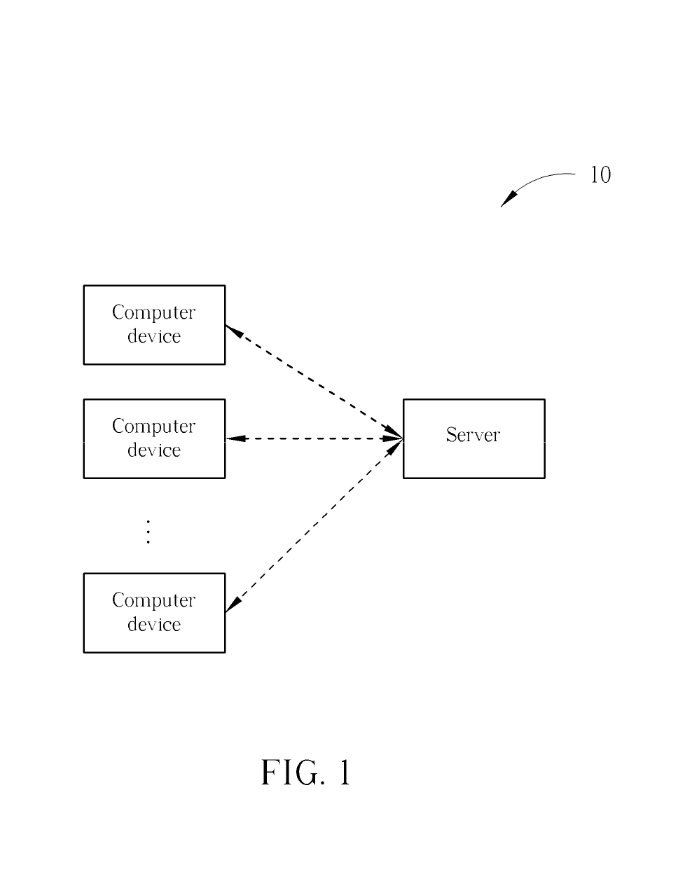

Please refer to FIG. 1, which is a schematic diagram of a network system 10 according to an example of the present invention. The network system 10 is briefly composed of a server and a plurality of computer devices. In FIG. 1, the server and the computer devices are simply utilized for illustrating the structure of the network system 10. Practically, the server can be an internal corporate information technology or an external service provider, such as Box, Dropbox or Google Drive, providing a shared storage. Besides, users can manage the shared storage by remote access in the computer devices.

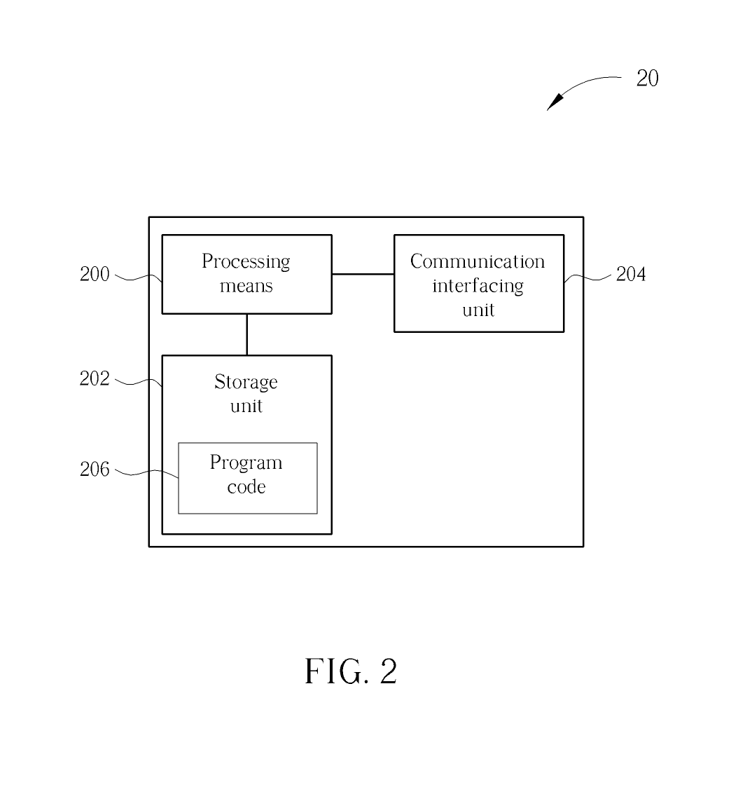

Please refer to FIG. 2, which is a schematic diagram of a computer apparatus 20 according to an example of the present invention. The computer apparatus 20 can be one of the computer devices shown in FIG. 1, but is not limited thereto. The computer apparatus 20 may include a processing means 200 such as a microprocessor or Application Specific Integrated Circuit (ASIC), a storage unit 202 and a communication interfacing unit 204. The storage unit 202 may be any data storage device that can store a program code 206, accessed and executed by the processing means 200. Examples of the storage unit 202 include but are not limited to read-only memory (ROM), flash memory, random-access memory (RAM), CD-ROM/DVD-ROM, magnetic tape, hard disk and optical data storage device. The communication interfacing unit 204 is preferably a transceiver and is used to transmit and receive signals (e.g., messages or packets) according to processing results of the processing means 200.

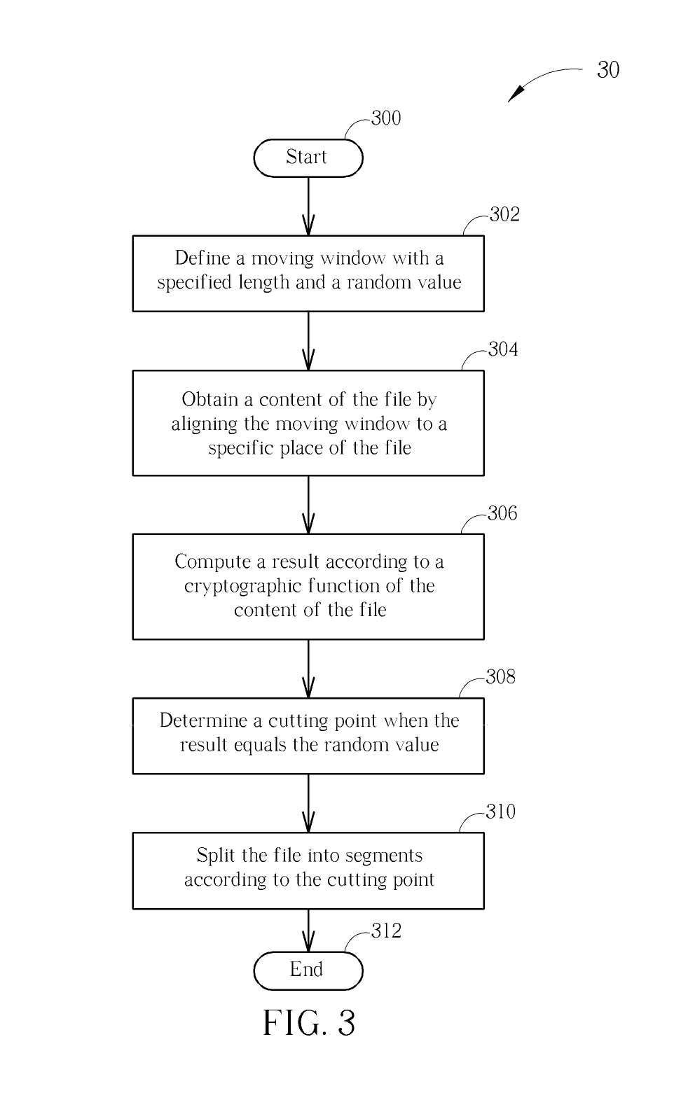

Please refer to FIG. 3, which is a flowchart of a process 30 according to an example of the present invention. The process 30 is utilized in the network system 10 shown in FIG. 1, for splitting a file stored in the shared storage by one of the computer devices, to efficiently encrypt the file. The process 30 can be implemented in the computer apparatus 20 and may be compiled into the program code 206. The process 30 includes the following steps:

Step 300: Start.

Step 302: Define a moving window with a specified length and a random value.

Step 304: Obtain a content of the file by aligning the moving window to a specific place of the file.

Step 306: Compute a result according to a cryptographic function of the content of the file.

Step 308: Determine a cutting point when the result equals the random value.

Step 310: Split the file into segments according to the cutting point.

Step 312: End.

According to the process 30, the computer device determines the cutting point according to the cryptographic function of the content of the file. When the result equals the random value, the cutting point is decided. Therefore, the cutting point is not subject to byte shifts and the cutting point is secure and confidential with the cryptographic computation for splitting the file.

In the process 30, the cryptographic function may be a cryptographically pseudo-random function. The cryptographically pseudo-random function can possess the following property:

(x,r(f₁(x),r(f₂(x), . . . r(fₘ(x))))˜U

wherein x denotes a random value, U denotes an uniform distribution, ˜ denotes computationally indistinguishable operation, m denotes a polynomial of the length of the moving window, f denotes a mapping function for the length of x, and r denotes the cryptographically pseudo-random function. In other words, since the cryptographic function is pseudo-random, the cutting point obtained according to the cryptographic function leads to be random and hence secure (that is, it leaks no information about file contents). Besides, the step of determining the cutting point can be shown as the following equation:

r(wⱼ)=v or r(wⱼ)≠v

wherein r denotes the cryptographically pseudo-random function, wⱼ denotes the j-th content of the file obtained by aligning the moving window to a specific place of the file, and v denotes the random value.

In detail, in cryptography, a pseudo-random function family, abbreviated PRF, is a collection of efficiently-computable functions which emulate a random oracle (a function whose outputs are fixed completely at random) in the following way: no efficient algorithm can distinguish between a function chosen randomly from PRF and a random oracle. PRF can be denoted by a set {rᵢ}, wherein each rᵢ is an efficiently-computable function indexed by i. The cryptographically pseudo-random function r mentioned in the embodiment of the present invention is accordingly chosen randomly from some PRF={rᵢ} by first choosing an index i=s at random and then set r=rₛ. Note the index i=s cannot be public, as otherwise we will lose the pseudo-randomness. Therefore, in the embodiment of the present invention, the index should be kept secret carefully along with the encryption keys for segments. The index in the previous paragraph of the present invention is omitted for simplicity. Additionally, the cryptographically pseudo-random function r is required to satisfy the property ((x,r(f₁)(x),r(f₂(x), . . . r(fₘ(x))))˜U), which is normally an intrinsic property of PRF in cryptography.

Note that, the process 30 is an example of the present invention, and those skilled in the art should readily make combinations, modifications and/or alterations on the abovementioned description and examples. For example, the cryptographic function can be replaced by another function possessing other properties as long as the function is cryptographic or even pseudo-random.

In another aspect, since the file is split into the variable length segments according to all cutting points obtained from the cryptographic function, the segments of the file can be further encrypted separately and securely. Moreover, when contents within a segment are changed, only the segment needs to be re-encrypted. Therefore, the efficiency of the encrypting operations for the file is increased and the file can also keep secure. In addition, the encrypting operations may operate in various encryption modes, such as a cipher block chaining (CBC) mode, a cipher feedback (CFB) mode, an output feedback (OFB) mode, a counter (CTR) mode and so on, but not limited herein.

In the present invention, the computer device decides the cutting point when the result obtained from the cryptographic function of the content of the file with the specified length is equal to the random value. Therefore, the cutting point can be secure and confidential with the computing operation of the cryptographic function. Since the cutting point is secure and confidential, the file can be efficiently encrypted and split according to the cutting point and further keep secure and confidential.

To sum up, the present invention provides a method and apparatus for splitting the file stored in the shared storage, to encrypt the file efficiently and keep the file secure and confidential.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for splitting a file in a computer device, the method comprising:
defining a moving window with a specified length and a random value;
obtaining a content of the file by aligning the moving window to a specific place of the file;
computing a result according to a cryptographic function of the content of the file;
determining a cutting point according to the result and the random value; and
splitting the file into segments according to the cutting point.

2. The method of claim 1, wherein the step of determining the cutting point according to the result and the random value is deciding the cutting point when the result equals the random value.

3. The method of claim 1, wherein the cryptographic function is a cryptographically pseudo-random function.

4. The method of claim 3, wherein the cryptographically pseudo-random function possesses the following property:
(x,r(f₁(x),r(f₂(x), . . . r(fₘ(x))))˜U
wherein x denotes a random value, U denotes an uniform distribution, ˜ denotes computationally indistinguishable operation, m denotes a polynomial of the length of the moving window, f denotes a mapping function for the length of x and r denotes the cryptographically pseudo-random function.

5. The method of claim 1, wherein the segments of the file are further encrypted separately.

6. A computer readable medium comprising multiple instructions stored in a computer readable device, upon executing these instructions, a computer performing the following steps:
defining a moving window with a specified length and a random value;
obtaining a content of a file by aligning the moving window to a specific place of the file;
computing a result according to a cryptographic function of the content of the file;
determining a cutting point according to the result and the random value; and
splitting the file into segments according to the cutting point.

7. The computer readable medium of claim 6, wherein the step of determining the cutting point according to the result and the random value is deciding the cutting point when the result equals the random value.

8. The computer readable medium of claim 6, wherein the cryptographic function is a cryptographically pseudo-random function.

9. The computer readable medium of claim 8, wherein the cryptographically pseudo-random function possesses the following property:
(x,r(f₁(x),r(f₂(x), . . . r(fₘ(x))))˜U
wherein x denotes a random value, U denotes an uniform distribution, ˜ denotes computationally indistinguishable operation, m denotes a polynomial of the length of the moving window, f denotes a mapping function for the length of x and r denotes the cryptographically pseudo-random function.

10. The computer readable medium of claim 6, wherein the segments of the file are further encrypted separately.

11. A computer device, comprising:
a processing means;
a storage unit; and
a program code, stored in the storage unit, wherein the program code instructs the processing means to execute the following steps:
defining a moving window with a specified length and a random value;
obtaining a content of a file by aligning the moving window to a specific place of the file;
computing a result according to a cryptographic function of the content of the file;
determining a cutting point according to the result and the random value; and
splitting the file into segments according to the cutting point.

12. The computer device of claim 11, wherein the step of determining the cutting point according to the result and the random value is deciding the cutting point when the result equals the random value.

13. The computer device of claim 11, wherein the cryptographic function is a cryptographically pseudo-random function.

14. The computer device of claim 13, wherein the cryptographically pseudo-random function possesses the following property:
(x,r(f₁(x),r(f₂(x), . . . r(fₘ(x))))˜U
wherein x denotes a random value, U denotes an uniform distribution, ˜ denotes computationally indistinguishable operation, m denotes a polynomial of the length of the moving window, f denotes a mapping function for the length of x and r denotes the cryptographically pseudo-random function.

15. The computer device of claim 11, wherein the segments of the file are further encrypted separately.
